(19) United States
(12) Patent Application Publication
(10) Pub. No.: US 2015/0151433 A1
(43) Pub. Date: Jun. 4, 2015

(54) COMPACT ROBOTIC GRIPPER

(71) Applicant: HARRIS CORPORATION, Melbourne, FL (US)

(72) Inventors: JOHN B. RUST, Indialantic, FL (US); Paul M. Bosscher, West Melbourne, FL (US); Matthew D. Summer, Melbourne, FL (US)

(73) Assignee: HARRIS CORPORATION, Melbourne, FL (US)

(21) Appl. No.: 14/093,785

(22) Filed: Dec. 2, 2013

(51) Int. Cl. B25J 15/00

(52) U.S. Cl. CPC B25J 15/0028

(57) ABSTRACT

Robot gripping system (200, 200′) includes a motor (202) mounted to a chassis (201). An elongated worm shaft (204) is rotatably mounted to the chassis along a worm axis (211) parallel to a motor rotation axis (209). A drive coupling (210) rotates the elongated worm shaft responsive to rotation of a motor drive shaft. First and second worm gears (205a, 205b) are disposed on the elongated worm shaft. First and second sector gears (206a, 206b) engage the first and second worm gear and rotate respectively about a first and second sector gear axis of rotation transverse to the worm axis. First and second robot gripper fingers (208a, 208b) are coupled to the first and second sector gears such that the fingers rotate about a proximal end (228a, 228b).

### BACKGROUND OF THE INVENTION

1. Statement of the Technical Field

The inventive arrangements relate to robotic systems and more particularly to gripping tools used by robotic system.

2. Description of the Related Art

Many robotic systems utilize gripper-style tools. Such robotic systems include industrial arms (used for assembly, material handling), mobile robots (used for bomb disposal, route clearance), domestic robots, undersea salvage robots and robots designed for space systems. In order to perform required functions, it is often necessary for gripping tools to provide high grip strength. Another design consideration concerns the physical size and form factor of a robotic gripping tool. It is often desirable for a gripping tool to have a relatively small physical volume. However, it can also be important to provide a gripping tool which has dimensions that are relatively compact. For example, in many applications it is desirable to provide a gripping tool which does not have a large length to width ratio.

Gripping tools generally include at least two opposing fingers which can be moved in an opening and closing operation to grasp an object which is disposed between the fingers. To this end, various mechanisms have been developed for effecting the movement of the fingers. For example, some gripping tools utilize linearly actuated fingers in which linear actuators drive the fingers on linear bearings. But these mechanisms tend to be bulky and are not particularly robust. Other gripping tools use rotary actuators with spur gears to move the fingers. These gripping mechanisms can be less complex than other designs but they are still relatively bulky in size. Another common design for a gripping mechanism uses a rotary actuator with a worm gear. Worm gear designs are advantageous for use in gripping tools because they offer high grip force (due to the high gear ratio), are lightweight, rugged and inexpensive.

### SUMMARY OF THE INVENTION

Embodiments of the invention concern a robotic gripping system. According to one aspect, the gripping system includes a rigid chassis and a rotary motor mounted to the chassis. The rotary motor is arranged to rotate a drive shaft of the rotary motor about a motor rotation axis. An elongated worm shaft is rotatably mounted to the chassis along a worm axis which is parallel to the motor rotation axis. A drive coupling is arranged to cause rotation of the elongated worm shaft about the worm axis in response to rotation of the drive shaft. A first worm gear and a second worm gear are disposed on the elongated worm shaft. A first sector gear and a second sector gear which respectively engage the first and second worm gear are rotatably mounted in the chassis and configured to rotate respectively about a first and second sector gear axis of rotation transverse to the worm axis. First and second robot gripper fingers are provided, each coupled at a proximal end to a respective one of the first and second sector gears. Each of the robot fingers is configured to rotate about its proximal end when the first and second sector gears are rotated by the drive shaft.

According to a second aspect, the robotic gripping system includes a gripper system chassis and a motor disposed in the chassis. The motor is arranged to rotate a motor drive shaft about a motor rotation axis of the motor. The robotic gripping system further includes a gripping assembly. The gripping assembly includes an elongated worm shaft including a worm gear rotatably mounted to the chassis in alignment with a worm axis parallel to the motor rotation axis. The gripping assembly further includes a sector gear positioned to engage the worm gears and rotatably mounted to the chassis to facilitate rotation about a sector gear axis transverse to the worm axis. The gripping assembly also includes a first elongated robot finger extending from the chassis and a second robot finger opposed from the first robot finger. The second robot finger is coupled at a proximal end to the sector gear and configured to rotate toward the first robot finger about the proximal end when the drive shaft is rotated in a closing rotation direction. A drive coupling is arranged to rotate the elongated worm shaft about the worm axis responsive to rotation of the drive shaft by the motor. A second such gripping assembly can also be provided stacked adjacent to the first gripping assembly such that the operation of the motor causes the second gripping finger in each gripping assembly to move as described herein.

According to another aspect, the system includes a gripper chassis in which a motor mounted. The motor includes rotor which rotates about a motor axis and a drive shaft. The drive shaft is coupled to the rotor and configured to rotate, responsive to rotation of the rotor, about a drive axis which is parallel to the motor axis. An elongated worm shaft is rotatably mounted to the chassis along a worm axis which is parallel to the drive axis. A drive coupling is arranged to cause rotation of the elongated worm shaft about the worm axis in response to rotation of the drive shaft. A first worm gear disposed on the elongated worm shaft and a first sector gear is provided which engages the first worm gear. The first sector gear is rotatably mounted to the chassis and configured to rotate about a first sector gear axis of rotation transverse to the worm axis. A first robot gripper finger is coupled at a first proximal end to the first sector gear and configured to rotate with the first sector gear.

### BRIEF DESCRIPTION OF THE DRAWINGS

Embodiments will be described with reference to the following drawing figures, in which like numerals represent like items throughout the figures, and in which:

FIG. 1 is a drawing that is useful for understanding certain limitations of a prior art robotic gripping device.

FIG. 2A is a front view of a compact robotic gripping system that is useful for understanding the invention.

FIG. 2B is a side view of the compact robotic gripping system in FIG. 2A.

FIG. 2C is a schematic representation which is useful for understanding a geometric relation between certain components of the compact robotic gripping system in FIG. 2A.

FIG. 3 is a drawing that shows a front view of the compact robotic gripping system of FIG. 2A in a closed grip position.

FIG. 4 is a drawing that shows a front view of the compact robotic gripping system of FIG. 2A in a fully open grip position.

FIG. 5A is a front view of a second embodiment of a compact robotic gripping system.

FIG. 5B is a side view of the compact robotic gripping system in FIG. 5A.

FIG. 5C is a schematic representation which is useful for understanding a geometric relation between certain components of the compact robotic gripping system in FIG. 5A.

FIG. 6 is a drawing that is useful for understanding an alternative arrangement of a compact robotic gripping system which includes an additional bearing.

FIG. 7 is a drawing that is useful for understanding an alternative arrangement of a compact robotic gripping system in which the drive coupling is disposed between two worm gears.

FIG. 8 is a drawing that is useful for understanding an alternative arrangement of a compact robotic gripping system which uses a gear drive coupling.

FIG. 9 is a drawing that is useful for understanding an alternative arrangement of a compact robotic gripping system in which the two fingers are independently controlled by two separate motors.

FIG. 10 is a drawing that is useful for understanding an alternative arrangement of a compact robotic gripping system in which parallel jaw actuation is provided.

FIG. 11 is a drawing that is useful for understanding an alternative arrangement of a compact robotic gripping system in which an encoder is provided at the base of a gripping finger.

FIG. 12A is a front view of a compact robotic gripping system including additional gripping fingers.

FIG. 12B is a side view of the compact robotic gripping system shown in FIG. 12A.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

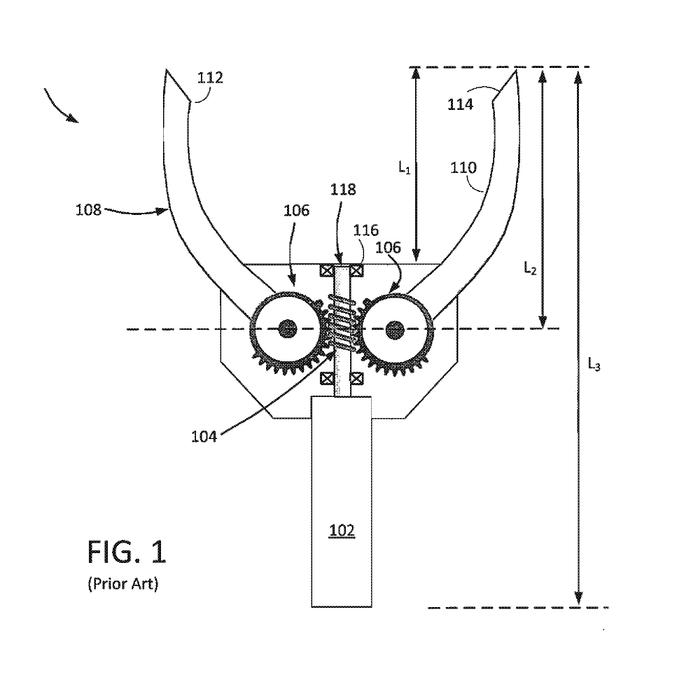

Referring now to FIG. 1 there is shown a conventional robotic gripping system 100 which includes a motor 102 that drives a worm gear 104. The motor is commonly chosen to be an electric motor because such motors are light-weight, easy to power, and easy to control. The worm gear 104 engages a pair of sector gears 106. When the motor output shaft is rotated in a first direction, the sector gears cause the distal ends 112, 114 of the fingers 108, 110 to rotate toward each other for gripping an object. When the output shaft is rotated in an opposite direction, the same sector gears cause the distal ends of the fingers to move away from each other for releasing an object from the grip of the robot gripping device.

The arrangement shown in FIG. 1 offers high grip force, is light in weight, and has few mechanical parts. Overall, it is an inexpensive and rugged design. Still, the arrangement suffers from certain disadvantages and particularly from poor length ratios. A first length ratio which is a measure of finger efficiency is defined as L1/L2. A second length ratio which has significant impact on robot arm design and performance criteria is defined as L1/L3. In the arrangement shown in FIG. 1, the first ratio L1/L2 is tends to be relatively too small because the bearings 116 and forward worm shaft end 118 protrude too far into the gripping area between the two fingers 112, 114. Ideally, the length L1, which represents the portion of each finger available for gripping, should be as close as possible to the overall length L2. But in the arrangement shown in FIG. 1, the bearings and worm shaft tend protrude into the gripping area and therefore limit the portion of each finger which can be practically used for grasping objects. Similarly, the second length ratio L1/L3 tends to be relatively too small. This deficiency is due in part to the reasons stated above with respect to the first length ratio, but it is also due to the form factor of the electric motor 102, which tends to be elongated as shown.

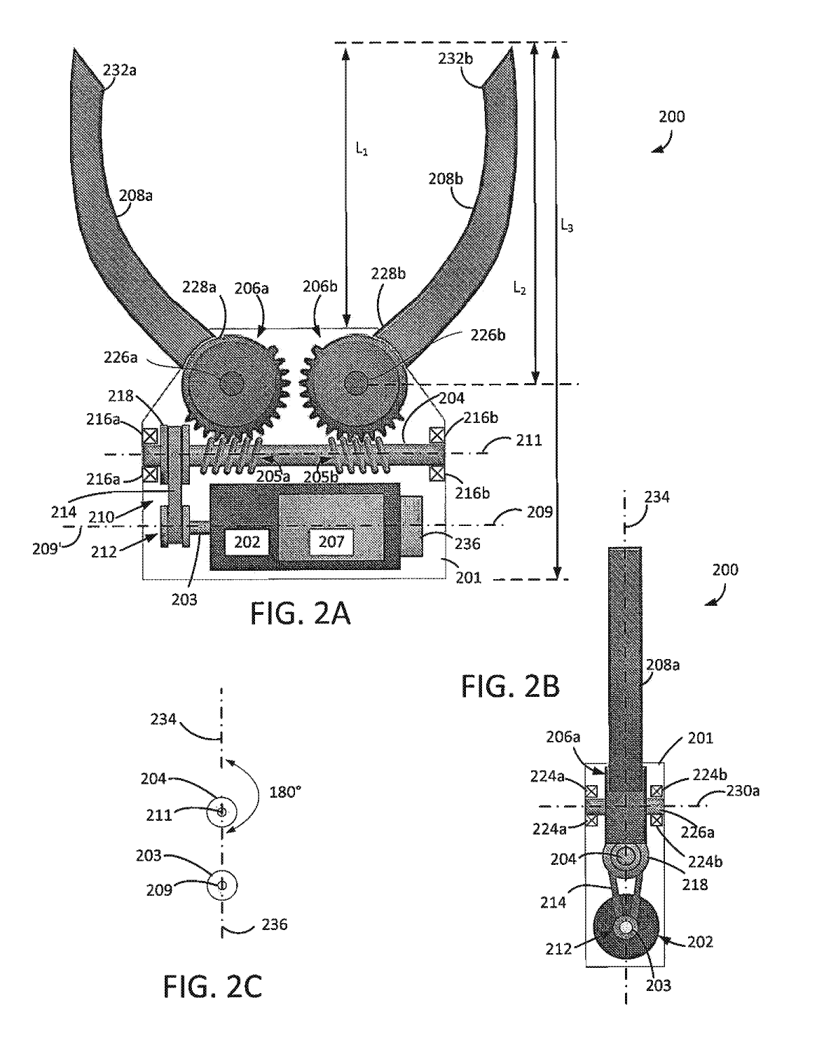

Shown in FIGS. 2A and 2B is a compact robotic gripping system 200 which has many of the advantages of a conventional gripping system as shown in FIG. 1, but offers a more compact arrangement with improved length ratios. The robotic gripping system includes a chassis 201 which forms a structural base and housing to which the various components described herein are mounted. The chassis is formed of a rigid material, such as metal or structural polymer. A motor 202 is provided and includes a rotatable drive shaft 203. The motor is mounted to the chassis by any suitable means so that it is fixed in position. The motor is a rotary type motor and can be powered by any suitable means. For example, an electric motor, a pneumatically operated motor, or a hydraulically operated motor can be used for this purpose. As is well known in the art, a rotary motor 202 will generally include at least one rotor 207 internal to the motor which rotates about a motor axis 209 for causing rotation of the drive shaft 203. For purposes of describing the invention, it shall be assumed that the motor is an electric motor that is electronically controlled so that the motor can cause the drive shaft to rotate in a forward or reverse direction of rotation about the motor axis.

The drive shaft 203 is coupled to the rotor and configured to rotate, responsive to rotation of the rotor, about a drive axis 209′ which is parallel to the motor axis 209. In FIG. 2A, it can be observed that the motor axis and the drive axis are the same such that the two components rotate about a common axis. Still, it should be appreciated that in some embodiments output gearbox assemblies can cause the drive axis 209′ to be offset with respect to the motor axis 209. An offset arrangement as described is acceptable for purposes of the present invention, provided that the drive axis should advantageously remain in parallel alignment with the motor axis to achieve certain advantages described herein. Also, in order to facilitate the compact design described herein, any such offset is preferably kept to a minimum.

An elongated worm shaft 204 is rotatably mounted within the chassis 201 along a worm axis 211 which is parallel to the drive axis 209′. Bearings 216a, 216b can be used to support the elongated worm shaft to facilitate such rotation. A drive coupling 210 is arranged so that rotation of the drive shaft will result in rotation of the elongated worm shaft about the worm axis. In FIGS. 2A and 2B a pulley and belt arrangement is used for this purpose. More particularly, a drive belt 214 extends around each of a drive shaft pulley 212 and worm shaft pulley 218. The drive belt can be a conventional v-belt arrangement. However, it is advantageous to utilize a toothed drive belt which has a plurality of teeth formed therein which are designed to engage with a plurality of toothed recesses formed in each pulley. Such an arrangement prevents slippage and provides a greater amount of control over finger movement as described herein.

First and second worm gears 205a, 205b are provided along the length of the elongated worm shaft 204 as shown. Worm gears are well known in the art and therefore will not be described here in detail. However, the worm gears 205a, 205b are each advantageously formed of a plurality of threads which are designed to engage with a plurality of threads on a respective sector gear 206a, 206b. In particular, a first sector gear 206a engages the first worm gear 205a, and the second sector gear 206b engages the second worm gear 205b. Each sector gear is rotatably mounted to the chassis and configured to rotate about a sector gear axis of rotation which is transverse to the worm axis. For example, each sector gear can be fixed to a respective gear shaft which rotates in a set of bearings. This concept is best shown in FIG. 2B which shows first sector gear 206a is fixed on gear shaft 226a. In this scenario, the gear shaft (and the sector gear) will rotate about sector gear axis of rotation 230a on bearings 224a, 224b. A similar arrangement is used for second sector gear 206b which is journaled on gear shaft 226b.

The robotic gripping system 200 further includes first and second robot gripper fingers 208a, 208b. Each gripper finger is coupled at a proximal end 228a, 228b to a respective one of the sector gears 206a, 206b such that each gripper finger will rotate when the corresponding sector gear is rotated. Accordingly, the gripper finger in each instance can be attached directly to one of the sector gears or can be fixed to one of the gear shafts 226a, 226b.

The threads comprising the first worm gear are cut to have a thread direction that is opposed to threads comprising the second worm gear. Accordingly, when the drive shaft causes the worm gear shaft to rotate, the first and second sector gears 206a, 206b will turn in opposite directions. When the drive shaft is rotated in a closing direction, it will cause the distal end 232a of the first robot gripper finger to move toward a distal end 232b of the second robot gripper finger. Conversely, when the drive shaft is rotated in an opposite direction (opening direction) it will cause the distal ends of the two robot fingers to move apart so as to release an object gripped between them.

Each of the first and second sector gears will have a plane of rotation which is perpendicular to the sector gear axis of rotation. The plane of rotation 234 for sector gear 226a is best shown in FIG. 2B. Sector gear 226b will have a plane of rotation that is parallel to and aligned with the plane of rotation 234. In the robotic gripping system shown in FIGS. 2A and 2B, the motor axis 209 and the drive axis 209′ are each disposed substantially in alignment with a plane of rotation defined by the first and second sector gears.

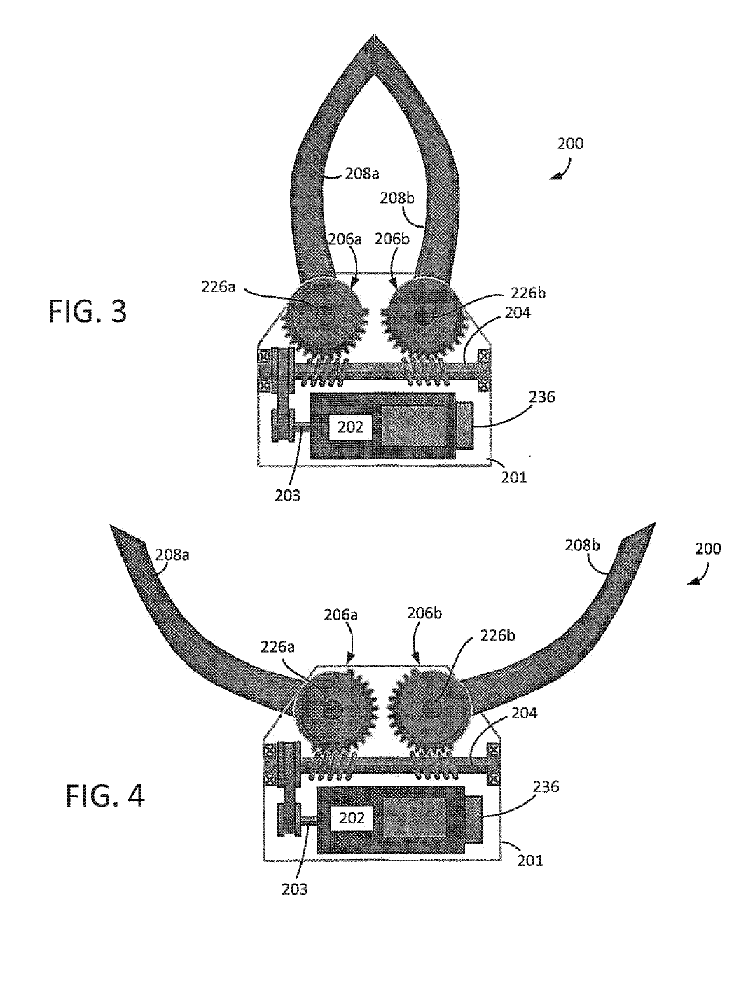

The robot gripper fingers 208a, 208b can rotate respectively about gear shafts 226a, 226b from a fully closed position shown in FIG. 3 to a fully open position shown in FIG. 4. As noted above, movement of the gripper fingers is controlled by the motor 202. The exact position of each gripper finger can be determined at all times by means of an encoder 236 which measures rotation of the drive shaft 203.

The robot gripper system 200 is substantially more compact as compared to a conventional worm drive robot gripper system 100. Notably, the robot gripper system 200 is absent of a worm gear and bearing which protrude into a gripping zone disposed between the gripper fingers. As such, the robot gripper system 200 can offer a substantial improvement in length ratio L1/L2 as compared to the robot gripper system 100. Also, in robot gripper system 200, the arrangement of the worm gear, drive coupling and motor facilitate a substantial improvement in the length ratio L1/L3 as compared to the robot gripper system 100.

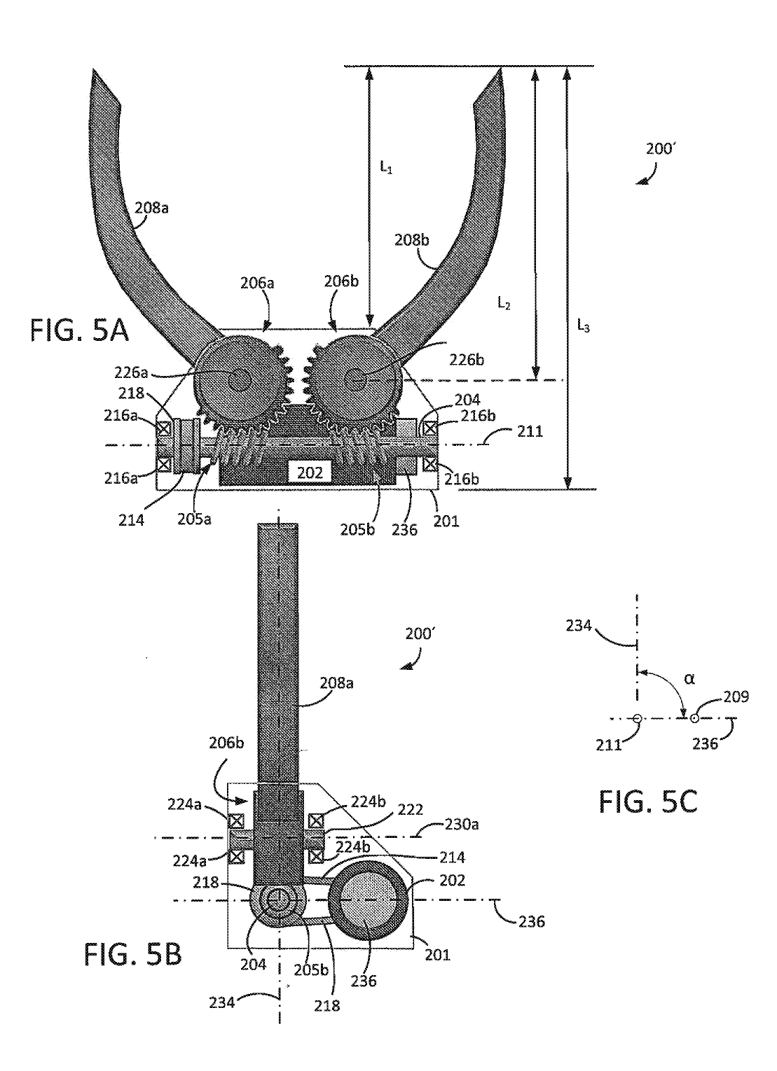

From the foregoing it will be appreciated that the robot gripper system shown in FIGS. 2-4 is a substantial improvement as compared to a conventional worm gear operated robot gripper design. However, the design can be improved further by arranging the motor 202 so that it is offset from the plane of rotation defined by the first and second sector gears. In order to understand this improvement, it is useful to refer to FIGS. 2B and 2C. It can be observed in FIG. 2C that there is an alignment plane 236 which is defined by the motor axis 209 and the worm axis 211. In the robotic gripping system shown in FIGS. 2A-4, the alignment plane 236 forms an angle of approximately 180° with the sector gear plane of rotation 234. However, the compactness of the robotic gripping system can be further improved by arranging the motor axis 209 so that the alignment plane 236 is rotated relative to the sector gear plane of rotation 234 to form an angle of less than 180°. Such an arrangement is illustrated in FIGS. 5A-5C which shows a robot gripper system 200′ in which a position of the motor 202 has been changed relative to plane of rotation 234.

More particularly, in FIGS. 5A-5C, the alignment plane 236 has been rotated so that it forms an angle α with the plane of rotation 234. As may be observed in FIG. 5C, α is less than 180° and thereby provides a more compact design for a robotic gripping system. In particular, when α is less than 180° it reduces the overall length L3 of the robotic gripping system. In the example shown α is approximately 90° but the invention is not limited in this regard. In fact any angle α is less than 180° will advantageously reduce the overall length L3. Accordingly, the inventive arrangements illustrated in FIGS. 5A-5C can include any configurations where the angle α falls in that range.

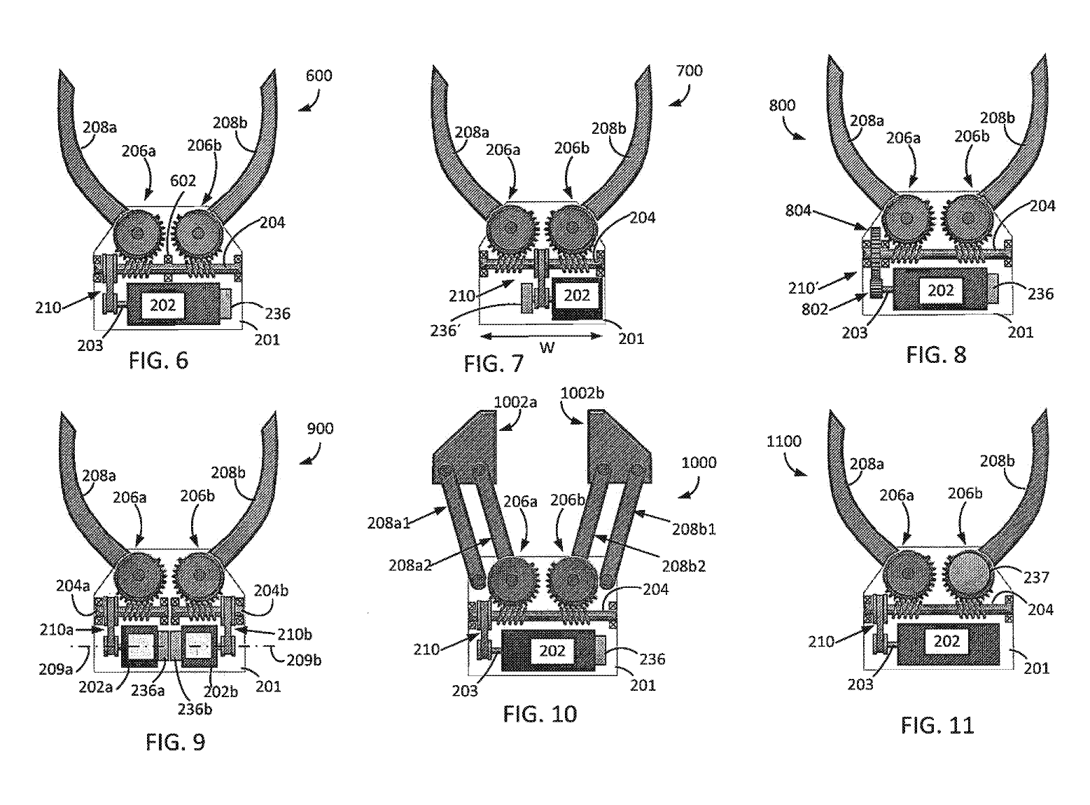

Referring now to FIGS. 6-11 there are illustrated several variations of a robotic gripping system. The variations are illustrated with respect to a configuration of a robotic gripping system similar to the system 200 shown in FIGS. 2-4. Still, it should be appreciated that the same variations can be applied with respect to the configuration of a robotic gripping system 200′ as shown in FIGS. 5A-5C. Each of these variations will now be described. Unless otherwise noted, all other aspects of the gripping systems shown in FIGS. 6-11 are the same or similar to those described in relation to gripping systems 200, 200′.

It can be observed in FIG. 6 that a robotic gripping system 600 can have a center bearing 602 provided for the worm shaft 204. Such an arrangement will aid in supporting the worm shaft, but increases the parts count and weight of the robotic gripping system. It can be observed in FIG. 7 that a robotic gripping system 700 can have a drive coupling 210 which engages the worm shaft 204 on a centerline which approximately bisects the length of the worm shaft. Such an arrangement will decrease a housing width W of the robotic gripping system, but can be expected to result in decreased motor torque since a length of motor 202 is decreased. In the robotic gripping system 700, it can be advantageous to dispose an encoder 236′ at an end of the drive shaft opposed to the motor 202 so as to further minimize width W. FIG. 8 illustrates an embodiment of a robotic gripping system 800 in which the drive coupling 210′ is optionally implemented as a gear drive system. In a gear drive system an output gear 802 mounted to the drive shaft 203 can drive a worm shaft drive gear which is keyed on the worm shaft.

In FIG. 9, illustrates an embodiment of a robotic gripping system 900. In robotic gripping system 900 two motors 202a, 202b and two drive couplings 210a, 210b are provided for independent control over the first and second gripping fingers 208a, 208b. Drive couplings 201a, 210b independently cause rotation of worm shafts 204a, 204b in response to respective rotation of each motor. Each worm shaft 204a, 204b has a worm gear which drives a corresponding sector gear as previously described. In such a scenario, it is advantageous to include two separate encoders 236a, 236b to separately measure the position of each motor. Each motor 202a, 202b will include a rotor configured to rotate around a motor axis 209a, 209b. The motor axes 209a, 209b are parallel. In some embodiments, the two motors can rotate about the same axis such that 209a and 209b are aligned. The advantage of such an arrangement is that it provides independent control over each gripping finger 208a, 208b. However, a disadvantage of this approach is that each finger will generally tend to have a decreased motor torque. This is because motors 202a, 202b will generally need to be smaller than a single motor 202 if they are to fit in the same compact form of the chassis 201. Other variations are also possible. For example, in some embodiments a gripping finger 208a could be fixed and only a single gripping finger 208b can be controlled by a motor 202b as described.

In FIG. 10 there is illustrated a robotic gripping system 1000 which includes gripping pads 1002a, 1002b which are each movable in coordination with a plurality of bar fingers 208a1, 208a2, 208b1, 208b2. In FIG. 10 only two bar fingers are shown for each gripping pad but additional bar fingers can be provided on opposing sides of the gripping pads (not shown). For example, a total of four bar fingers can be provided for each gripping pad. As may be observed in FIG. 10, less than all of the bar fingers can be driven by a sector gear 206a, 206b. For example, the bar fingers 208a1 and 208b1 can be passive bar fingers which move in response to the movement of active bar fingers 208a2 and 208b2. An advantage of the arrangement shown in FIG. 10 is that it offers parallel movement of gripping pads 1002a, 1002b. However, this arrangement will naturally have increased complexity and will add weight to the design.

FIG. 11 shows a robotic gripping system 1100 in which an encoder 237 is positioned to directly measure the motion of a sector gear 206b or a gripping finger 208b. Such direct measurement of finger motion can provide greater precision of measurement but a drawback of this approach is that it adds bulk and weight to the base of the finger.

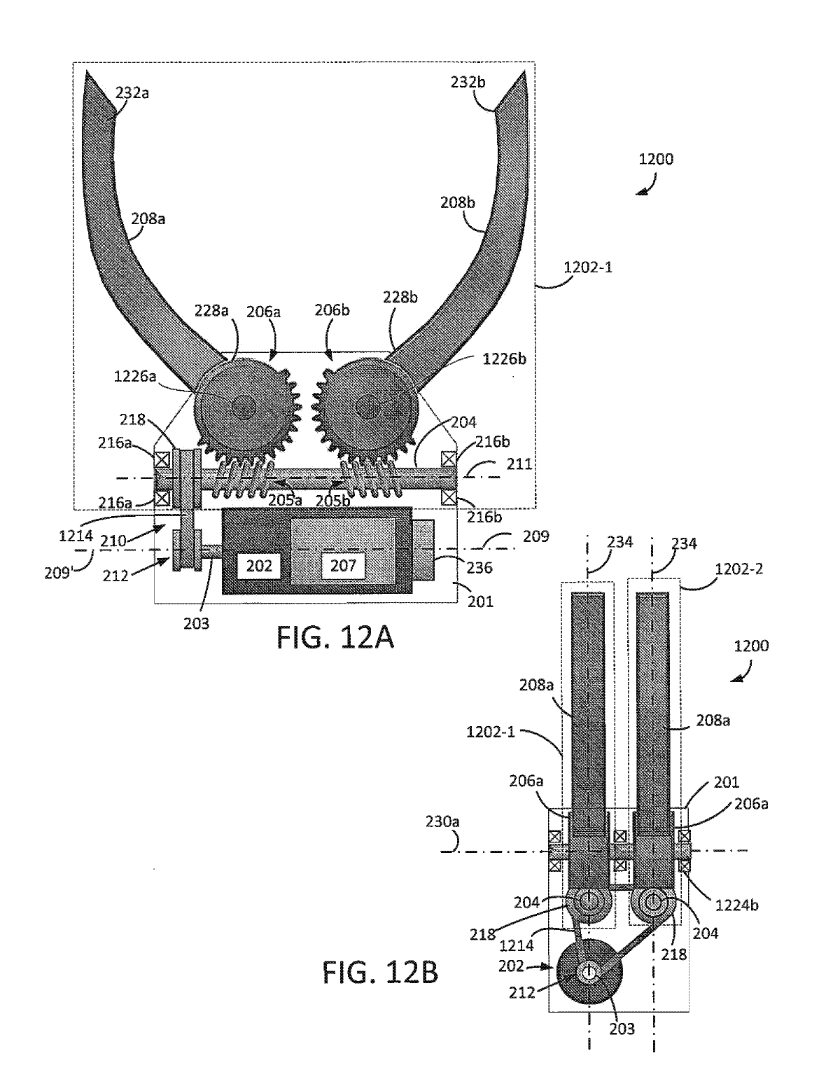

A design for a robot gripping device as disclosed in FIGS. 2-11 can be extended to an arbitrary number of gripper fingers by stacking one or more gripping assemblies as shown in FIGS. 12A and 12B. As illustrated therein, a robotic gripping system 1200 is comprised of a plurality gripping assemblies 1202-1, 1202-2. Each gripping assembly is similar to a robotic gripping system 200 except that it does not include a separate motor 202. Instead, a single motor 202 drives a belt 1214 which engages pulleys 218 in each gripping assembly. This operation causes rotation of the worm shaft 204 in each gripping assembly, which in turn causes rotation of sectors gears 206a, 206b. Rotation of the sector gears in each assembly causes motion of the gripper fingers 208a, 208b as previously described. The sector gears 206a in each assembly can rotate separately about axis 230a on independent gear shafts 1226a. Similarly, the sector gears 206b in each assembly can rotate separately on independent gear shafts 1226b. Still, the invention is not limited in this regard and in some embodiments all sector gears 206a can rotate in tandem on a common gear shaft 1226a. Similarly, all sector gears 206b can rotate on a common gear shaft 1226b. Additional gripping assemblies can be stacked in a similar manner to provide additional gripping fingers.

In an alternative embodiment, not shown, each gripping assembly 1202-1, 1202-2 can be provided with a separate motor 202 and a separate drive belt 1214 so that the operation of that gripping assembly can be independently controlled. If there is a need to independently control each gripping finger 208a, 208b, then two motors (202a, 202b) can be used for each gripping assembly in an arrangement similar to that which is shown in FIG. 9. In another alternative embodiment, a single worm shaft 204 can be driven by means of the belt 1214. The gripping fingers 208a in each of the gripping assemblies can then be fixed to a common gear shaft 1226a. The gripping fingers 208b in each of the gripping assemblies can also be fixed to a common gear shaft 1226b. Accordingly, each set of gripping fingers will move together on a common gear shaft in response to rotation of the worm shaft 204.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.)

We claim:

1. A robotic gripping system, comprising:
a chassis;
a motor mounted to the chassis, the motor comprising a rotor configured to rotate around a motor axis;
a drive shaft coupled to the rotor and configured to rotate, responsive to rotation of the rotor, about a drive axis which is parallel to the motor axis;
an elongated worm shaft rotatably mounted to the chassis along a worm axis which is parallel to the drive axis;
a drive coupling arranged to cause rotation of the elongated worm shaft about the worm axis in response to rotation of the drive shaft;
a first worm gear disposed on the elongated worm shaft;
a first sector gear which engages the first worm gear is rotatably mounted to the chassis and configured to rotate about a first sector gear axis of rotation transverse to the worm axis;
a first robot gripper finger coupled at a first proximal end to the first sector gear and configured to rotate with the first sector gear.

2. The robotic gripping system according to claim 1, further comprising:
a second worm gear disposed on the elongated worm shaft;
a second sector gear which engages the second worm gear is rotatably mounted to the chassis and configured to rotate about a second sector gear axis of rotation transverse to the worm axis;
a second robot gripper finger coupled at a second proximal end to the second sector gear and configured to rotate with the second sector gear.

3. The robotic gripping system according to claim 2, wherein a first plurality of threads comprising the first worm gear have a thread direction opposed to a second plurality of threads comprising the second worm gear.

4. The robotic gripping system according to claim 2, wherein the first and second sector gears are responsive to rotation of the drive shaft to cause a first distal end of the first robot gripper finger to move toward a second distal end of the second robot gripper finger when the drive shaft is rotated in a closing direction of rotation.

5. The robotic gripping system according to claim 1, wherein the motor axis is disposed in alignment with a plane of rotation defined by the first sector gear.

6. The robotic gripping system according to claim 1, wherein the motor axis is disposed offset from a plane of rotation defined by the first sector gear.

7. The robotic gripping system according to claim 6, wherein an alignment plane defined by the motor axis and the worm axis forms an angle of less than 180° relative to the plane of rotation.

8. The robotic gripping system according to claim 2, wherein the drive coupling includes one of a pulley and a gear disposed at one end of the elongated worm shaft.

9. The robotic gripping system according to claim 2, wherein the drive coupling includes one of a pulley and a gear disposed on the elongated worm shaft between the first worm gear and the second worm gear.

10. The robotic gripping system according to claim 1, further comprising:
a second motor mounted to the chassis, the second motor comprising a second rotor configured to rotate around a second motor axis and coupled to a second drive shaft;
a second elongated worm shaft rotatably mounted to the chassis along a second worm axis;
a second drive coupling arranged to cause rotation of the second elongated worm shaft about the second worm axis in response to rotation of the second drive shaft;
a second worm gear disposed on the second elongated worm shaft;
a second sector gear which engages the second worm gear is rotatably mounted to the chassis and configured to rotate about a second sector gear axis of rotation transverse to the second worm axis;
a second robot gripper finger coupled at a first proximal end to the second sector gear and configured to rotate with the second sector gear.

11. The robotic gripping system according to claim 10, wherein the first and second robot fingers are independently operable.

12. The robotic gripping system according to claim 10, wherein the first and second sector gears are independently responsive to rotation of first and second motors to cause a distal end of the first robot gripper finger to move toward a distal end of the second robot gripper finger when the first and second motors are operated in a closing direction of rotation.

13. The robotic gripping system according to claim 10, wherein the second motor axis is disposed in alignment with a plane of rotation defined by the second sector gear.

14. The robotic gripping system according to claim 10, wherein the second motor axis is disposed offset from a plane of rotation defined by the first sector gear.

15. A robotic gripping system, comprising:
a chassis;
a rotary motor mounted to the chassis, the rotary motor configured to rotate a drive shaft of the rotary motor about a motor rotation axis;
an elongated worm shaft rotatably mounted to the chassis along a worm axis which is parallel to the motor rotation axis;
a drive coupling arranged to cause rotation of the elongated worm shaft about the worm axis in response to rotation of the drive shaft;
a first worm gear and a second worm gear disposed on the elongated worm shaft;
a first sector gear and a second sector gear which respectively engage the first and second worm gear are rotatably mounted to the chassis and configured to rotate respectively about a first and second sector gear axis of rotation transverse to the worm axis;
first and second robot gripper fingers, each coupled at a proximal end to a respective one of the first and second sector gears and each configured to rotate about the proximal end when the drive shaft is rotated.

16. The robotic gripping system according to claim 15, wherein a first plurality of threads comprising the first worm gear have a thread direction opposed to a second plurality of threads comprising the second worm gear.

17. The robotic gripping system according to claim 15, wherein the first and second sector gears are responsive to rotation of the drive shaft to cause a distal end of the first robot gripper finger to move toward a distal end of the second robot gripper finger when the drive shaft is rotated in a closing direction of rotation.

18. The robotic gripping system according to claim 15, wherein the motor axis is disposed in alignment with a plane of rotation defined by the first and second sector gears.

19. The robotic gripping system according to claim 15, wherein the motor axis is disposed offset from a plane of rotation defined by the first and second sector gears.

20. The robotic gripping system according to claim 15, wherein the drive coupling is comprised of a toothed belt.

21. A robotic gripping system, comprising:
a chassis;
a motor arranged to rotate a motor drive shaft about a motor rotation axis of the motor;
a gripping assembly comprising:
an elongated worm shaft including a worm gear rotatably mounted to the chassis in alignment with a worm axis parallel to the motor rotation axis;
a sector gear positioned to engage the worm gears and rotatably mounted to the chassis to facilitate rotation about a sector gear axis transverse to the worm axis;
a first elongated robot finger extending from the chassis;
a second robot finger coupled at a proximal end to the sector gear and configured to rotate toward the first robot finger about the proximal end when the drive shaft is rotated in a closing rotation direction; and
a drive coupling arranged to rotate the elongated worm shaft about the worm axis responsive to rotation of the drive shaft by the motor.

22. The robotic gripping system according to claim 21, further comprising a second the gripping assembly disposed adjacent to the first gripping assembly, wherein a second worm axis of the second the gripping assembly is parallel to the worm axis of the gripping assembly.

23. The robotic gripping system according to claim 22, wherein the drive coupling is arranged to further rotate a second elongated worm shaft of the second gripping assembly.
